(19) United States
(12) Patent Application Publication
(10) Pub. No.: US 2025/0062462 A1
(43) Pub. Date: Feb. 20, 2025

(54) ONE-PIECE GASKET FOR A SECONDARY CELL

(71) Applicant: NORTHVOLT AB, Stockholm (SE)

(72) Inventors: Michael KOMA, Västerås (SE); Dongho SON, Stockholm (SE); Rakshith BELLARY, Västerås (SE)

(21) Appl. No.: 18/790,294

(22) Filed: Jul. 31, 2024

(30) Foreign Application Priority Data
Aug. 16, 2023 (SE) 2350969-8

(51) Int. Cl. H01M 50/184

(52) U.S. Cl. CPC H01M 50/184

(57) ABSTRACT

There is disclosed herein a one-piece gasket for a cylindrical secondary cell, comprising a first section configured to form a seal between a terminal assembly of the secondary cell and a casing of the secondary cell, and a second section configured to extend between and thereby electrically insulate an internal surface of the casing and a current collector.

### BACKGROUND

### Related Field

The present disclosure relates to a terminal rivet for a secondary cell, a secondary cell comprising the terminal rivet, and a method of manufacturing such a secondary cell.

### Related Art

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### BRIEF SUMMARY

The present disclosure aims to provide improved secondary cells and parts thereof. The improvements may be in energy performance, manufacturing efficiency, decreased amount of material used, and assembly simplification, among others.

In particular, according to an aspect of the present disclosure, there is provided a one-piece gasket for a cylindrical secondary cell, comprising a first section configured to form a seal between a terminal assembly of the secondary cell and a casing of the secondary cell, and a second section configured to extend between and thereby electrically insulate an internal surface of the casing and a current collector.

By using a gasket with an effective ‘built-in’ insulator part—which could also be seen, from another perspective, as being an insulator with a ‘built-in’ gasket part—the overall number of parts and process steps required to manufacture a secondary cell can be advantageously reduced.

Moreover, an insulator part, arranged internally in the cell between a current collector or electrode assembly and a casing, may be a tight fit in the casing. During installation of the terminal assembly (which may be riveted to form a terminal rivet), or during installation of other parts of the cell, the insulator may risk becoming pinched and subsequently uneven, risking exposure of internal components to the casing, without electrical isolation therebetween. By combining the insulator with the gasket, as a single part, which is joined and arranged around a terminal assembly in an assembly process, the risk of such wrinkling can be reduced or removed.

In some examples, the one-piece gasket (which may be referred to hereinafter as simply ‘the gasket’) may be formed entirely from one material. In such examples, the gasket is preferably entirely formed of polyphenylene sulfide, PPS, ethylene propylene diene monomer, EPDM rubber, polyethersulphone, PES, or polyketone, PK. It is realized as a part of the present disclosure that these materials demonstrate beneficial attributes of elasticity (for forming a good water-tight seal), and electrical insulation, while resisting chemical corrosion, wear due to physical abrasion, thermal damage due nearby welding, and being relatively low in cost.

In other examples, the first section is formed of a different material than the second section. In a preferred example of such examples, the first section is formed of PPS and the second section is formed of EPDM. The first and second sections may be formed together, e.g., through over-molding or 3D printing techniques, or may be formed separately and then joined together. In this way, a material with superior elastic properties and/or chemical suitability for contact with an electrolyte may be chosen specifically for the first section, and a material with superior electrically insulating properties may be chosen for the second section, without further constraints. Hence, lower cost materials may be used (needing only to fulfil a subset of the requirements of the gasket as a whole) while providing an overall improvement in the function of the gasket.

The gasket may further comprise a third section configured to extend between and thereby electrically insulate the terminal assembly of the secondary cell and an external surface of the casing. As discussed above in respect of the first and second sections, the third section may be formed of the same material as the first and second sections, or of a different material than the first section and/or the second section.

Thus, the third section of the gasket acts as electrical insulation between a flat external surface of the casing and the terminal assembly (e.g., a rivet head thereof). The terminal assembly may form an external terminal of the cell, e.g. a positive terminal via a connection to the cathode part of the electrode assembly. The negative terminal may be all or part of the casing, such as the casing at least on the same side as that at which the terminal assembly is arranged. Thereby, both terminals of the secondary cell are provided on the same side of the cell, being electrically insulated from each other via the third section of the gasket. Accordingly, it is realized as a part of the present disclosure that electrical creep along a surface between the terminals is a notable consideration in the design of the third section of the gasket. Indeed, with increasing electrical capacity of cells, at full charge, there may be a substantially high electrical potential between the terminals.

Therefore, in preferred examples of the present disclosure, the third section radially extends a first radial distance beyond the head of the terminal assembly, and a sum of the first radial distance and a thickness of the gasket at least in the third section is configured to prevent electrical creepage between the terminals of the cell. The first radial distance is preferably 1.5 to 2 mm.

The gasket preferably has a substantially constant thickness, as this advantageously simplifies the manufacture of the gasket. However, the gasket may be shaped and bent to extend through the opening of the casing and back on itself, or to form a lip around the head of the terminal assembly. That is, the third section may further comprise a lip extending away from the external surface of the casing, configured to substantially surround the head of the terminal assembly. The lip may be formed a localized thickening of the gasket or as a bend or flange in a constant-thickness gasket (which may function as an effective localized thickening).

Hence, the radial extension of the third section of gasket beyond the head of the gasket may be limited by virtue of the provision of a lip, as the sum of the first radial distance and the thickness of the third section can be increased through an increase in the latter.

An advantageous implementation of the present disclosure comprises the second section radially extending to 80% to 100% of the radius of the secondary cell, preferably 95% to 100%, or 0 to 0.05 mm from the curved wall of the casing. Thus, the gasket may entirely replace the function of an insulator, by reliably electrically insulating the current collector from the casing of the cell.

To further reduce the number of components required for separate manufacture and installation, the gasket may comprise fourth section configured to extend between and thereby electrically insulate the electrode assembly of the secondary cell and an internal sidewall surface of the casing. Hence, the presence of such a fourth section may remove a need for insulation tape (i.e., tape on the cathode disc and/or electrode assembly).

As discussed above, there is provided as a further aspect of the present disclosure a cylindrical secondary cell comprising an electrode assembly housed in a cylindrical casing, a current collector arranged in direct electrical contact with the electrode assembly, and a terminal assembly extending through an opening in the casing and arranged in direct electrical contact with the current collecting plate.

According to said aspect, the cell comprises a one-piece gasket substantially as described above, wherein the first section of the one-piece gasket is arranged around the terminal assembly to form a seal in the opening of the casing, and wherein the second section of the one-piece gasket extends between the current collecting plate and the casing to thereby electrically insulate the current collecting plate from the casing.

Although the terminal assembly and the current collector are described as being separate parts, the terminal assembly and the current collecting plate may instead be formed as a single piece, thereby further reducing the number of parts and process steps required for manufacturing the secondary cell.

The current collecting plate is preferably arranged in abutment with the second section of the one-piece gasket to thereby optimize a volumetric efficiency (and thus an energy density) of the cell.

It will be appreciated by those skilled in the art, and through the description of example embodiments of the present disclosure, that further advantages as well as those described above may be provided by a one-piece gasket according to aspects of the present disclosure.

### BRIEF DESCRIPTION OF THE DRAWINGS

One or more embodiments of the present disclosure will be described, by way of example only, and with reference to the following figures, in which:

FIG. 1 schematically shows a cross-sectional view of a secondary cell comprising a one-piece gasket according to aspects of the present disclosure;

FIG. 2 schematically shows an enlarged portion of the secondary cell shown in FIG. 1;

FIG. 3 schematically shows top and bottom views of a top section of the cell shown in FIG. 1, comprising a one-piece gasket according to an example implementation of the present disclosure;

FIGS. 4A and 4B show alternative implementations of a one-piece gasket according to an example implementation of the present disclosure wherein the gasket is formed of multiple materials; and

FIG. 5 schematically shows a same enlarged portion of the cell as shown in FIG. 2, wherein the gasket has a lip and an additional fourth section.

### DETAILED DESCRIPTION

The present disclosure is described in the following by way of a number of illustrative examples. It will be appreciated that these examples are provided for illustration and explanation only and are not intended to be limiting on the scope of the present disclosure. Instead, the scope of the present disclosure is defined by the appended claims.

Furthermore, although embodiments be presented individually for the sake of focused discussion of particular features, it will be recognized that the present disclosure also encompasses combinations of the embodiments described herein.

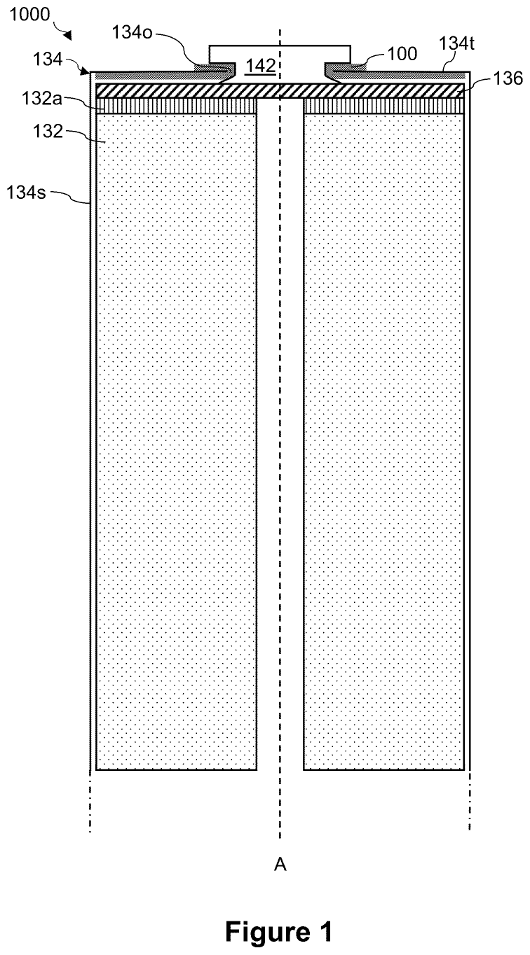

FIG. 1 schematically shows a cross-sectional view of a cylindrical secondary cell 1000 comprising a terminal assembly formed as a rivet 142 extending through an opening 1340 in the casing 134, and having a one-piece gasket 100 arranged therearound.

The cylindrical secondary cell 1000 (also referred to as simply the ‘cell 1000’) comprises an electrode assembly (or ‘roll’) 132 housed in a cylindrical casing 134. The electrode roll 132 may be formed of an anode sheet, a cathode sheet, and a separator sheet arranged therebetween to thereby enable a storage of electrical energy. Cathode tabs 132a may extend from a first end of the electrode roll 132 and anode tabs (not shown) may extend from the other end, or vice versa. The cathode tabs 132a and anode tabs provide connective surfaces to which current collectors 136 can be connected. As used here, the “tabs” 132a can be uncoated portions of the electrode foil extending from the electrode roll 132, rather than additional tabs connected to the electrode roll 132. Hence, the illustrated cell 1000 may be referred to as a ‘tabless’ cell due to the absence of ‘additional’ tabs.

The cylindrical casing 134 extends along an axis A between a first end 134t, which may be referred to as a ‘top end 134t’, and a bottom end (not shown) which may be an open end of the casing 134 closed by a lid. The closure of the casing may comprise a clamped closure or a welded closure, depending on the implementation.

For example, the casing 134 may further comprise a beading groove (not shown) formed in the side wall 134s. Hence, between the beading groove and the end edge of the side wall towards the bottom end of the casing, a clamping portion can be formed. A lid gasket may then be clamped around the bottom lid in the clamping portion to thereby seal the open bottom end of the casing. Providing a clamped closure in this way is well known in the art and thus can provide a reliable waterproof seal for the cell.

As another example, the lid may be welded to the casing to thereby seal the casing. The lid may be additionally welded to a current collector, or the lid may act as a current collector itself and be attached (e.g., welded) to the tabs of the electrode assembly 132. Providing a welded closure in this way may advantageously remove the number of components of the cell and/or the number of process steps required to manufacture the cell.

A cathode current collecting plate 136 is arranged in direct electrical contact with the cathode tabs 132a and an anode current collecting plate (not shown) may be arranged in direct electrical contact with the anode tabs (also not shown). Here, the labels ‘cathode’ and ‘anode’ may be swapped. Thus, an electrical connection is formed from the cathode tabs 132a to the terminal assembly, as the terminal assembly is connected to the current collecting plate 136.

An electrical connection may also formed from the anode tabs to the casing 134, either directly or through connection of an anode current collecting plate to the casing 134, e.g. in the clamping portion or by welding. One or both or the current collectors may be formed as a disc, a plate, or have some other shape.

At either end of the cell, the cell may further comprise a vent for venting gases, for example during a failure of the cell. Moreover, the cell may comprise an additional through-hole, in the casing and/or the lid, for filling the cell with a liquid electrolyte. This through-hole is preferably adapted to be closed from the outside, such as through the use of a blind rivet.

Thus, it is seen that a head of the terminal assembly 142 serves as an external terminal of the cell 1000, this being a positive terminal in this example, and the casing 134 serves as the negative terminal. Hence, it is seen that both terminals of the cell 1000 are accessible at the same side. The top end 134t of the casing 134 comprises a first electrical contact surface extending in a first plane, and the head of the rivet 142 comprises a second electrical contact surface, extending in a second plane axially spaced from the first plane.

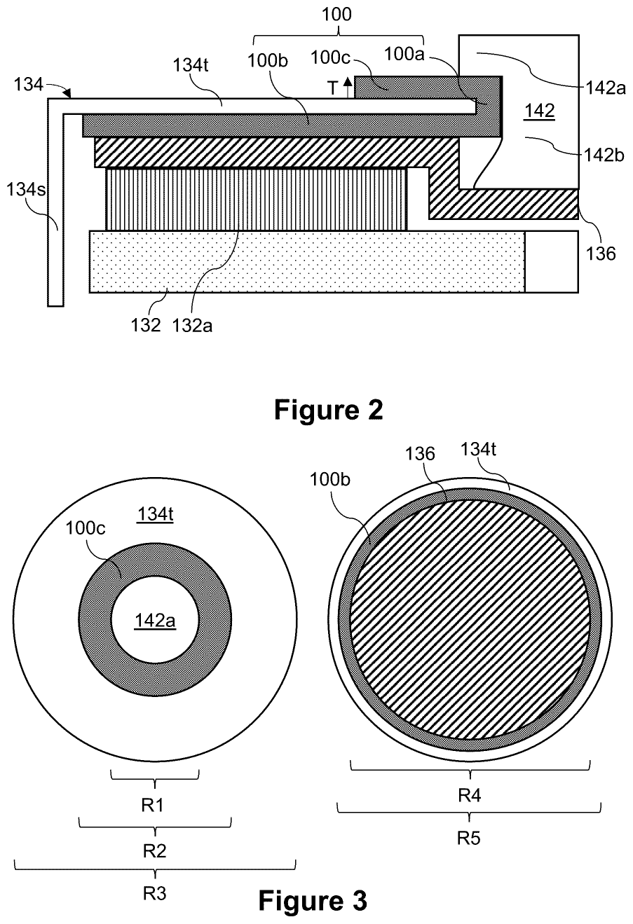

Arranged around the terminal assembly 142 is a gasket 100 configured to form a fluid-tight seal for the opening 1340 in the top end 134t of the casing 134, shown in more detail in FIG. 2, said figure having corresponding numbered references.

A first section 100a of the gasket 100 is arranged at least around the shaft 142b of the terminal assembly 142. A second section 100b of the gasket 100 extends between and thereby electrically insulates an internal surface of the top 134t of the casing 134 and the current collector 136. Specifically, as shown in FIG. 3, the second section 100b of the gasket 100 extends (see R5) at least to a same radius (R4) as the full extent of the current collector 136 to ensure an electrical insulation of the current collector 136 from the casing 134 even if the cell 1000 is shaken or subject to a shock or impact. Hence, the second section 100b of the gasket 100 extends substantially all the way to the side wall 134s of the casing 134, i.e., such that R5˜R3.

A third section 100c of the gasket 100 further extends (see R2) between the head 142a of the rivet 142 and the top end 134t of the casing 134 so as to electrically isolate the opposite terminals of the cell 1000 from each other. As shown most clearly in FIG. 3, the third section 100c radially extends beyond the head of the rivet 142, such that R2>R1, so as to protect against electrical creepage between the top surface 134t of the casing 134 (acting as the negative terminal) and the terminal rivet assembly 142 (acting as the positive terminal).

In preferred examples, a thickness T of the gasket 100 (or at least the third section thereof 100c), summed with the radial extension beyond the head 142a of the terminal assembly 142 (i.e., R2-R1) is configured to prevent electrical creepage between the terminals of the cell 1000 (i.e., between the top 134t of the casing 134 and the terminal assembly 142). The distance R2-R1 may be referred to as a first radial distance, and this distance may preferably be between 1.5 and 2 mm (inclusive).

It will be appreciated that, although the current collector 136 and the terminal assembly 142 have been illustrated and discussed as separate components, they may in fact be formed together as a single piece, in some embodiments of the present disclosure.

Thus, it can be seen that gasket 100 serves multiple purposes. The gasket 100 may be preferably formed of a polymer having elastic, resilient, and electrically insulating properties, such as polyphenylene sulfide (PPS), ethylene propylene diene monomer (EPDM) rubber, polyethersulphone, (PES), or polyketone (PK).

In some examples, different sections of the gasket 100 may be formed of different materials, each section being specifically configured for a respective purpose. For example, for the first section of the gasket 100 around the opening 1340 and intended to seal the opening, the gasket 100 may be formed of PPS. For the second and third sections of the gasket 100, intended primarily to electrically components from each other, the gasket 100 may be formed from EPDM rubber.

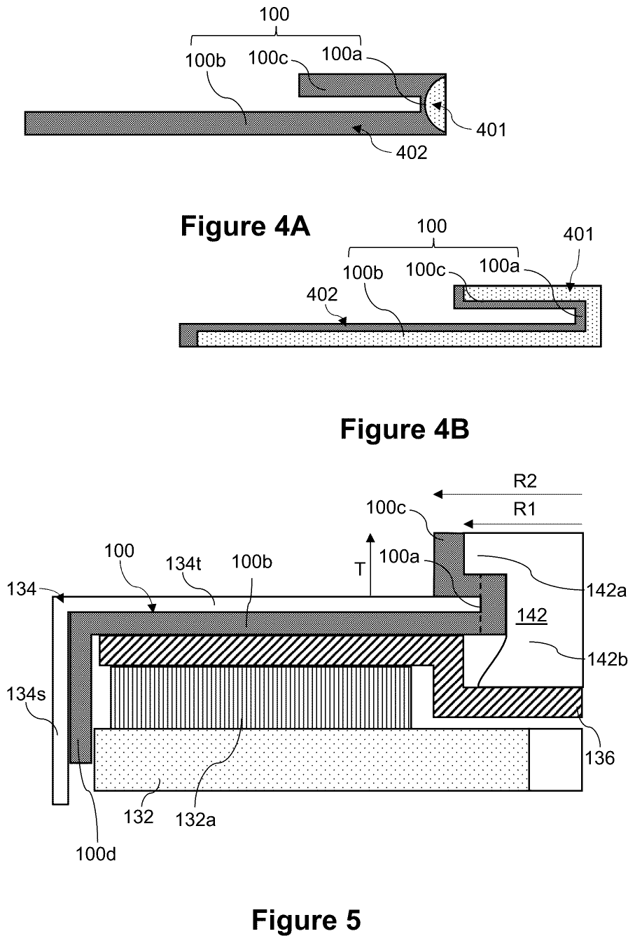

FIGS. 4A and 4B show alternative example implementations of such a two-material one-piece gasket. The sections of the gasket are the same as those shown in FIG. 2.

FIG. 4A shows an example wherein a first material 401 is localized to the first section 100a of the gasket 100, and a second material 402 is used for the second section 100b and the third section 100c. It can be seen that a part of the first section 100a also comprises the second material 402, which may be for structural purposes or to benefit from the properties of the second material 402 also in the first section 100a.

The first material 401 may be much more expensive than the second material 402, thereby necessitating its sparing use, but may nonetheless have particularly superior qualities in respect of forming a water-tight seal, thermal and/or chemical resilience, or other properties that may be of particular benefit, e.g. exclusively or more-so in the first section 100a of the gasket 100. It will be appreciated that a reverse example could be constructed whereby an electrically insulating material is used sparingly in the second section 100b and/or third section 100c.

FIG. 4B shows an example wherein the first and second materials 401, 402 are overlaid as continuous layers. It can be seen that, as a result, the first material 401 is most exposed to an inside of the cell and the second material 402 is most in contact with a casing of the cell (not shown).

Thus, the first material 401 may be chosen to have superior chemical resilience such that it resists decomposition when in contact with, e.g., a liquid electrolyte in the cell. The second material 402 may be chosen to have superior frictional qualities to aid in the insertion of the gasket 100 and prevention of wrinkling when the gasket 100 is inserted in the cell and other components are installed therearound (such as during the riveting of the rivet).

It will be appreciated that more than two materials may be used in other examples, depending on the implementation, in other arrangements.

The gasket 100 may be formed of two or more materials by injection molding, over-molding, 3D printing, and/or other techniques known to those skilled in the art.

FIG. 5 schematically shows a similar partial view of a cell as that shown in FIG. 2, but with a different form for the gasket 100. According to this illustrated example, the third section 100c of the gasket 100 is formed with a lip extending away from the top part 134t of the casing 134 (i.e., the flat end of the cylindrical casing 134). This is an effective increase in the thickness T of the gasket 100 in the third section 100c, although it will be appreciated that the gasket 100 need not be manufactured with a differing thickness to achieve such a lip, as the lip could also be formed, for example, by bending or otherwise angling the gasket 100 to form this flange-like lip.

It will be appreciated that the third section 100c being formed as a lip in this way may prevent electrical creep to a similar degree as the configuration of the third section 100c as shown in FIG. 2. However, the radial extension of the third section 100c beyond the head 142a of the terminal assembly 142 (i.e., R2-R1) is lesser, due to the increased thickness T. Hence, a greater surface area for connection to a negative terminal, formed by the external surface of the top part 134t of the casing 134, is advantageously provided.

Further according to this illustrated example, the gasket 100 further comprises a fourth section 100d extending between and thereby electrically insulating the electrode assembly 132 of the secondary cell and an internal sidewall surface 134a of the casing 134. Hence, it may not be required to isolate the electrode assembly and/or current collector 136 from the casing 134 using isolation tape, thereby further reducing the number of parts and/or the number of process steps required to manufacture the cell.

While the present disclosure is susceptible to various modifications and alternative forms, specific embodiments are shown and described above by way of example in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims.

1-13. (canceled)

14. A one-piece gasket for a cylindrical secondary cell, comprising:
a first section configured to form a seal between a terminal assembly of the secondary cell and a casing of the secondary cell; and
a second section configured to extend between and thereby electrically insulate an internal surface of the casing and a current collector,
wherein the first section is formed of a different material than the second section.

15. The gasket according to claim 14, further comprising a third section configured to extend between and thereby electrically insulate a head of the terminal assembly of the secondary cell and an external surface of the casing.

16. The gasket according to claim 15, wherein the third section is formed of a different material than the first section and/or the second section.

17. The gasket according to claim 16, wherein the third section radially extends a first radial distance beyond the head of the terminal assembly, and a sum of the first radial distance and a thickness of the gasket at least in the third section is configured to prevent electrical creepage between the terminals of the cell.

18. The gasket according to claim 15, wherein the third section radially extends a first radial distance beyond the head of the terminal assembly, and a sum of the first radial distance and a thickness of the gasket at least in the third section is configured to prevent electrical creepage between the terminals of the cell.

19. The gasket according to claim 14, wherein the gasket has a substantially constant thickness.

20. The gasket according to claim 15, wherein the third section further comprises a lip extending away from the external surface of the casing, configured to substantially surround the head of the terminal assembly.

21. The gasket according to claim 14, wherein the second section radially extends to 80% to 100% of the radius of the secondary cell or 0 to 0.05 mm from the curved wall of the casing.

22. The gasket according to claim 14, wherein the second section radially extends to 95% to 100% of the radius of the secondary cell or 0 to 0.05 mm from the curved wall of the casing.

23. The gasket according to claim 14, further comprising a fourth section configured to extend between and thereby electrically insulate the electrode assembly of the secondary cell and an internal sidewall surface of the casing.

24. A cylindrical secondary cell comprising:
the one-piece gasket according to claim 14,
an electrode assembly housed in a cylindrical casing;
a current collecting plate arranged in direct electrical contact with the electrode assembly;
a terminal assembly extending through an opening in the casing and arranged in direct electrical contact with the current collecting plate; and
wherein:
the first section of the one-piece gasket is arranged around the terminal assembly to form a seal in the opening of the casing; and
the second section of the one-piece gasket extends between the current collecting plate and the casing to thereby electrically insulate the current collecting plate from the casing.

25. The cylindrical secondary cell according to claim 24, wherein the terminal assembly and the current collecting plate are formed as a single piece.

26. The cylindrical secondary cell according to claim 25, wherein the current collecting plate is arranged in abutment with the second section of the one-piece gasket.

27. The cylindrical secondary cell according to claim 24, wherein the current collecting plate is arranged in abutment with the second section of the one-piece gasket.
